(19) United States
(12) Patent Application Publication
(10) Pub. No.: US 2007/0199402 A1
(43) Pub. Date: Aug. 30, 2007

(54) Pedal Bearing Block

(75) Inventors: Matthias Plagmann, Hamburg (DE); Eckhard Reese, Apensen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/563,750

(22) PCT Filed: Jul. 8, 2004
(86) PCT No.: PCT/EP04/07449

§ 371 Date: Feb. 20, 2007

(30) Foreign Application Priority Data
Jul. 9, 2003 (DE) 103 30 893.8

(51) Int. Cl. G05G 1/14

(52) U.S. Cl. 74/512

(57) ABSTRACT

The invention relates to a pedal bearing block for receiving a pedal. The pedal bearing block has a basic body, a connecting point for fastening the pedal bearing block to a front wall, and a bearing point 13 for receiving a pedal bearing. In order to produce the pedal bearing block compactly and favorably, the basic body of the pedal bearing block has a shell 1 and a reinforcing element 11 assigned to the shell 1.

### CROSS-REFERENCE TO RELATED APPLICATIONS

This is a U.S. National Phase of International Application No. PCT/EP2004/007449, filed Jul. 8, 2004, and claims the benefit of priority under 35 U.S.C. §119 based on DE 103 30 893.8, filed Jul. 9, 2003, the entire disclosures of which are incorporated herein by reference.

### BACKGROUND AND SUMMARY OF THE INVENTION

The invention relates to a pedal bearing block for a motor vehicle.

German Patent Document 100 17 794 A1 discloses a pedal bearing block which is of single-part design. Only one material can be used in a single-part design of a pedal bearing block. A pedal bearing block of plastic requires a large amount of construction space in order to achieve the necessary stiffness. By contrast, a compact pedal bearing block of metal has a high weight. Although the weight is reduced when light metals are used, high material costs arise.

EP 1 052 562 A3 discloses a pedal bearing block for receiving a pedal for a motor vehicle, with a basic body. The basic body comprises a shell and a reinforcing element assigned to the shell.

Against this background, the present invention is based on the object of providing a pedal bearing block of the type mentioned at the beginning which can be produced at low weight and cost-effectively and at the same time requires little construction space.

This object is achieved by a pedal bearing block distinguished by a basic body with two separate components, a shell and a reinforcing element. The reinforcing element has a stiffening function. The multipart design of the basic body enables the shell and the reinforcing element to be formed from different materials, with it being possible for the positive properties of the individual materials to be combined with one another. For example, plastic has a low weight and metal high stability. As a result, in a compact construction of the pedal bearing block the stiffness can be increased and the weight reduced at the same time.

In order to provide the basic body with basic stability, according to one embodiment said basic body consists of metal, such as, for example, steel plate. In the case of a compact construction, steel permits a higher strength than a plastic component with the same dimensions.

In order to further increase the stiffness of the shell, according to a further embodiment the shell has a collar on its encircling edge. If, in conjunction with the invention, a collar is discussed, then what is meant by this is an outer edge of the shell which is essentially bent at right angles. This collar also optimizes the force flux in the pedal bearing block. A force introduced into the pedal bearing block via a pedal is distributed over a large area via the collar, as a result of which individual regions of the pedal bearing block are relieved of load.

For the furthermore required stability of the shell, according to a further embodiment an additional plastic reinforcing element is injection molded on the shell. Plastic parts have the advantage that they have a lower weight and can be produced more cost-effectively in comparison to metal parts with identical dimensions. Furthermore, the plastic parts can be injection molded onto the shell of the basic body by injection molding processes. In this connection, no complicated adaptation of the plastic part to the shell is necessary, since, during the injection molding operation, the plastic part is automatically matched to the shell which forms part of the injection mold. Tolerances therefore do not have to be taken into consideration, which makes the production considerably more favorable in terms of costs.

As an alternative to the conventional injection molding process, it is also conceivable to use a foam injection molding technology to produce the plastic part or reinforcing element. Central element of the process is a gas supply unit. A foaming agent, for example NO₂, is injected under a pressure of 100 to 200 bar into a plastic melt. The foaming agent dissolves in the plastic melt and expands upon injection, with it expanding the plastic. A microcellular structures is therefore obtained.

In comparison to conventional injection molding, foam injection molding permits a homogeneous structure, little distortion and the shaping of thin-walled regions. In addition, this process provides a saving of weight of up to 30%, since better mechanical properties specific to the weight are achieved. Owing to system-inherent properties, such as lower retaining, cooling and cycle times, reduction in the machine size because of a lower pressure level, improvement in the melt viscosity and reduction of waste, cost reductions are obtained. The possible retrofitting of conventional machines and the use of standard injection molds are likewise to be stressed as being positive. The foam injection molding process is suitable for known plastics, in particular for PA, PP, POM, TPE/PP.

Owing to the advantages cited, foam injection molding is eminently suitable for combination with hybrid technology to assist the lightweight construction.

In order to produce the reinforcing element as cost effectively as possible, according to a further embodiment the reinforcing element has a rib structure in the interior of the metal shell. As a result, the desired stability is accompanied by a saving in a simple manner on material and weight and the costs are therefore reduced.

According to a further embodiment, a bearing point for a pedal bearing is placed into the shell and the reinforcing element which is injection molded both onto the outside and inside of the shell. Since great forces are introduced into the bearing point by a pedal, the bearing point has to have a high strength. By means of the multipart, sandwich-like construction of the bearing point, it is possible to provide the bearing point with basic stability by means of a metal core which corresponds to the shell. The reinforcing element has the task of forming the actual pedal bearing.

According to a further embodiment, the bearing point has ribs arranged axially and radially to the longitudinal axis of the pedal bearing, for reinforcement. Ribs have the advantage that they save both material and weight while providing optimum reinforcement. As a result, the costs are further reduced.

According to a further embodiment, the two parts of the basic body are connected fixedly to each other. For this purpose, the collar of the shell is at least partially encapsulated with plastic by injection molding, so that the reinforcing element is secured on the shell. Furthermore, the shell has permeating holes in the form of recesses in the shell, into which the plastic of the reinforcing element is injected. As a result, the injection molded reinforcing element is likewise fixed on the shell. This is a simple and cost-effective type of fastening, since neither additional fastening elements are required nor are additional working steps necessary.

So that the pedal bearing block can receive different additional elements, according to a further embodiment fastening possibilities are provided on the reinforcing element. These fastening possibilities can be produced in a simple manner by corresponding adaptation of the injection molds and can be connected to the pedal bearing block in a simple manner. In this case, no additional fastening means are required.

Other objects, advantages, and novel features of the present invention will become apparent from the following detailed description of the invention when considered in conjunction with the accompanying drawings, for example.

### BRIEF DESCRIPTION OF THE DRAWINGS

FIG. 1 shows a perspective view of a first embodiment of a shell of a pedal bearing block according to the invention;

FIG. 2a shows a perspective front view of the pedal bearing block according to the invention with the shell according to FIG. 1;

FIG. 2b shows a perspective rear view of the pedal bearing block according to the invention according to FIG. 2a;

FIG. 3 shows a perspective view of a second embodiment of a shell of the pedal bearing block according to the invention, and

FIG. 4 shows a perspective view of the pedal bearing block according to the invention with the shell according to FIG. 3.

### DETAILED DESCRIPTION

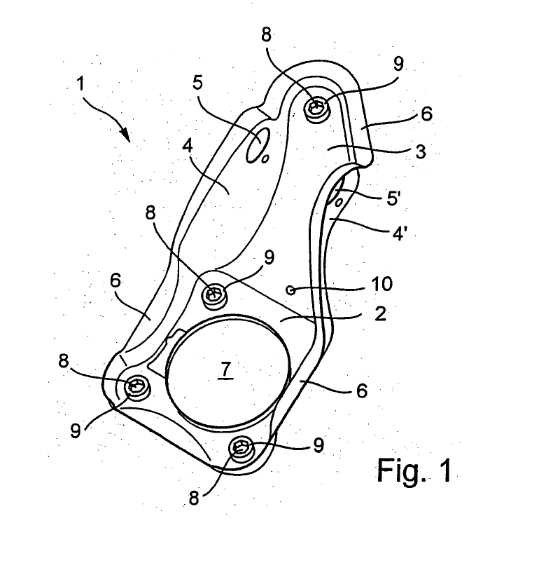

FIG. 1 illustrates a shell 1 of metal which forms part of a basic body of the pedal bearing block according to the invention. The shell 1 is composed of a deep-drawn steel plate and has a flat base 2, a curved base 3 and two side walls 4, 4′. The flat base 2 and the curved base 3 are arranged next to each other, so that the curved base 3 is arranged above the flat base 2 in FIG. 1. The curved base 3 is enclosed both laterally and at the top by the side walls 4, 4′. The flat base 2 is only surrounded laterally by the side walls 4, 4′. By means of the side walls 4, 4′, the shell 1 forms an inner space. In the side walls 4, 4′, two holes 5, 5′ for receiving a pedal bearing are arranged in the region of the curved base. An encircling edge 6 of the shell 1 is bent off at right angles at the side walls 4, 4′ and above the bearing region. The flat base 2 is shaped rectangularly and in the centre has a large, circular recess 7 through which a transmission element (not illustrated specifically) is guided. The transmission element passes on a movement of a brake pedal to a brake unit (not illustrated). Furthermore, three further small circular recesses 8 into which the bushings 9 are pressed are arranged circumferentially around the recess 7 in the flat base 2. The shell 1 is fastened by the flat base 2 to a front wall of a vehicle. The bushings 9 serve to receive fastening elements for connecting the shell 1 to the front wall. A further recess 8 with a bushing 9 which is pressed into it and is for connecting the shell 1 to the front wall is situated in the curved base 3 above the receptacle for the pedal bearing.

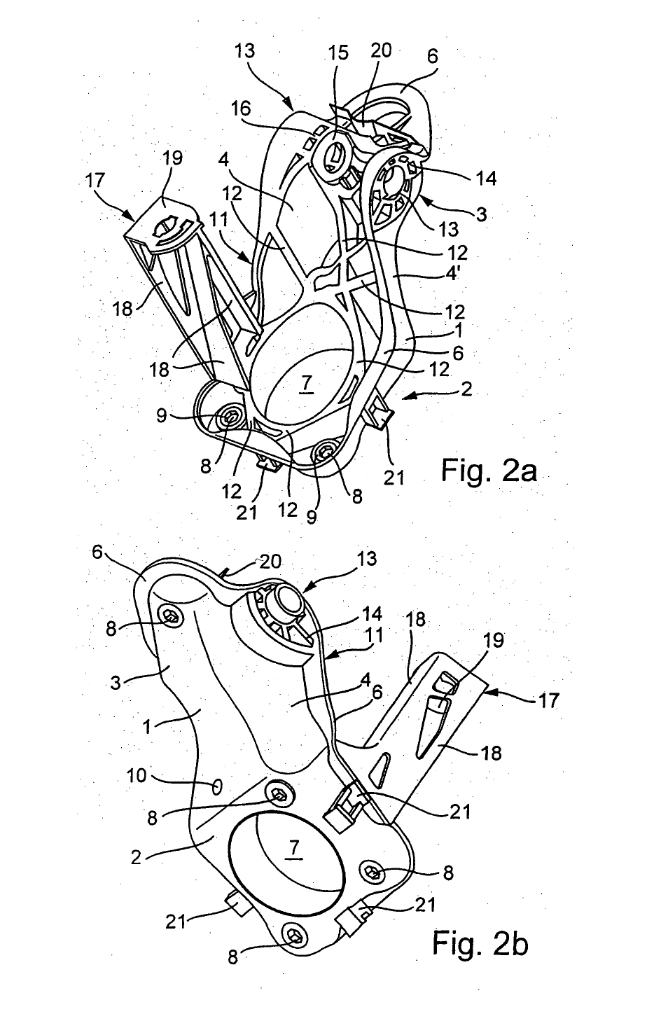

A permeating hole 10 in the form of a circular recess which serves to secure a reinforcing element 11 on the shell is arranged in the transition region from the flat base 2 to the curved region 3. The reinforcing element 11 is explained in more detail in FIGS. 2a and 2b. The reinforcing element 11 is injected into the inner space of the shell 1. In the process, the material of the reinforcing element 11 penetrates through the permeating hole 10 of the shell 1 and, as a result, fixes the reinforcing element 11 on the shell 1.

FIGS. 2a and 2b reveal a multipart pedal bearing block according to the invention. The pedal bearing block has a shell 1, as illustrated in FIG. 1, and a reinforcing element 11. The reinforcing element 11 consists of plastic, such as, for example, PA6 GF 30%, and is injected into the inner space of the shell 1 in the form of ribs to increase the stiffness of the shell 1, with the recess 7 of the shell 1 remaining free. Both the adjusted edge 6 and the bushings 9 are encapsulated with the plastic of the reinforcing element 11 by injection molding. As a result, the reinforcing element 11 is connected fixedly to the shell 1. The flat base 2 is entirely covered with plastic in the region of the bushings 9. The bushings 9 protrude out of the base covered with plastic and are additionally reinforced annularly with plastic on their outside, so that the bushings 9 and a ring arranged around the bushings 9 have a surface ending flush.

The reinforcing element 11 has ribs 12 which run irregularly in the region of the curved base 3 in the inner space of the shell 1. Thus, one rib 12 runs, for example, from the side wall 4 to the recess 7, a second rib 12 runs from the opposite side wall 4′ to the recess 7 and a third rib 12 runs between the two side walls 4, 4′ and, in the process, crosses one of the previously mentioned ribs 12. The ribs 12 extend in depth from the edge 6 of the shell 1 as far as the curved base 3. In the region of the flat base 2, the ribs 12 of the reinforcing element 11 form tangents around the recess 7 of the shell 1.

On the side walls 4, 4′ in the region of the holes 5, 5′, the reinforcing element 11 forms bearing points 13 for a pedal bearing. The bearing points 13 are injection molded onto the outside and inside of the side walls 4, 4′. The bearing points 13 are in the form of a sleeve penetrating through the holes 5, 5′ in the side walls 4, 4′. An outwardly protruding part of the sleeve is reinforced by ribs 14 which are in each case arranged radially to a longitudinal axis of the pedal bearing between the sleeve and that edge 6 of the shell 1 which is positioned closest. The bearing point 13 on the side wall 4 is additionally reinforced in the inner space of the shell 1 by an annular plate 15. The plate 15 is connected by reinforcing ribs 16, which are arranged axially to the longitudinal axis of the pedal bearing, to the sleeve-shaped bearing point 13. In this embodiment, this bearing point 13 on the side wall 4 is, owing to the construction space present, wider than the bearing point 13 opposite it on the side wall 4′ according to FIG. 2a. However, it is also conceivable to dimension the two bearing points 13 identically.

Between the recess 7 in the flat base 2 and the side wall 4, a holder 17 for receiving a light switch is injection molded onto the reinforcing element 11. The holder 17 comprises two lateral struts 18 which are arranged at right angles to each other and are covered with a receiving plate 19. A third strut 18 runs diagonally from the shell 1 to the receiving plate 19 and connects the two lateral struts 18 to each other. The receiving plate 19 of the holder 17 has a hole for fixing the light switch to a rectangular driving cut-out.

Furthermore, a plastic surface 20 which is injection molded onto the reinforcing element 11 is arranged above the bearing points 13 for the pedal bearing. The plastic surface 20 runs over the entire width of the basic body and serves to cover a noise capsule (not illustrated) which is placed onto the pedal bearing block on the side of the reinforcing element 11. The noise capsule is connected to the pedal bearing block by means of three latching lugs 21. The latching lugs 21 are injection molded onto the outside of the shell 1 circumferentially around the recess 7 below the edge 6 which is encapsulated with plastic by injection molding.

One of the bushings 9 next to the recess 7 of the shell 1 protrudes a little out of the shell 1 in the direction of the front wall and serves as a connecting point for a crash deflector, for example.

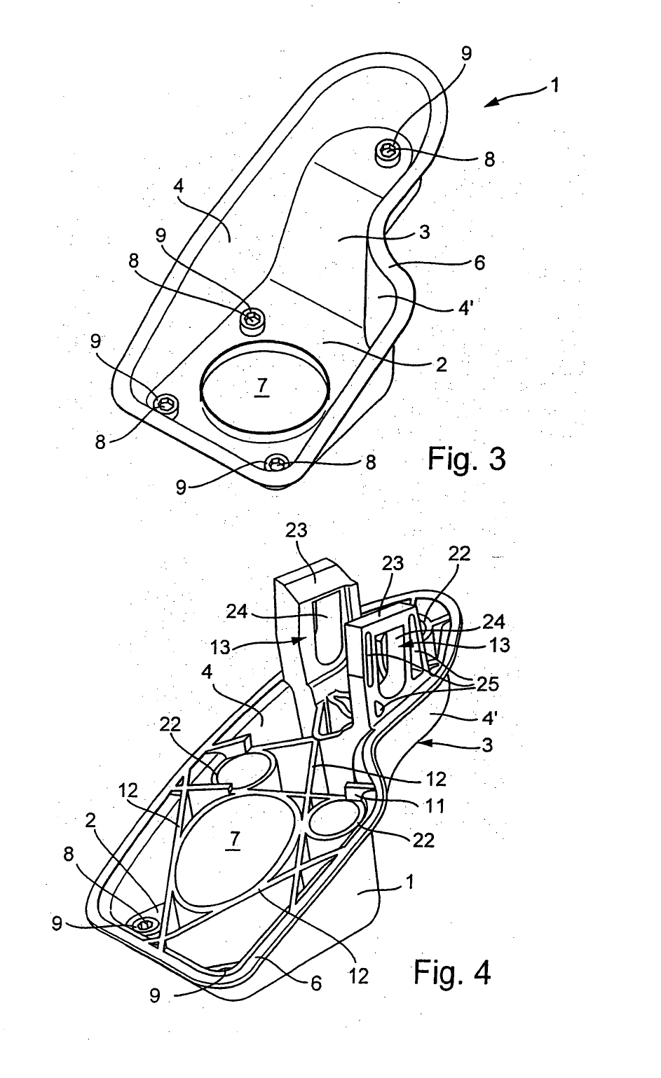

FIG. 3 illustrates a further exemplary embodiment of a shell 1 of the pedal bearing block according to the invention. In contrast to the shell 1 illustrated in FIG. 1, the shell 1 has side walls 4, 4′ arranged circumferentially around the two bases 2, 3. A continuous, outwardly adjusted edge 6 is provided on the side walls 4, 4′. Furthermore, no recesses for bearing points 13 are provided in the side walls 4, 4′ of the metal shell 1. The bearing points 13 are injection molded onto the shell 1 with the plastic reinforcing element 11. This is explained in conjunction with the exemplary embodiment illustrated in FIG. 4.

FIG. 4 reveals a further embodiment of a pedal bearing block. A reinforcing element 11 is injection molded onto the shell 1 according to FIG. 3. In addition to the ribs 12 running in the inner space of the shell 1, in the region of the flat base 2, the reinforcing element 11 has reinforcements 22 which are in the form of hollow cylinders and are oriented with their longitudinal axis perpendicular to the flat base 2. The reinforcements 22 are adjacent to the recess 7, which is encapsulated in the form of a hollow cylinder with plastic by injection molding. A further reinforcement 22 in the form of a hollow cylinder is arranged in the region of the curved base 3 above the receptacle for the pedal bearing. In contrast to the exemplary embodiment of the pedal bearing block that is illustrated in FIGS. 2a and 2b, the bearing points 13 consist of plastic. They are placed in formations which are injection molded onto the reinforcing element 11 above the side walls 4, 4′. The formations 23 are essentially cuboidal and on their large side surface in each case have a central cut-out 24 in the form of a slot. The slots serve as free spaces for levers and are accordingly shaped. The cuboidal formations 23 also have material cut-outs 25 on their outside in order to save material and weight.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-7. (canceled)

8. A pedal bearing block for receiving a pedal for a motor vehicle, comprising:
a basic body shell including a shell reinforcing element;
a connecting point for fastening the pedal bearing block to a front wall of the body shell; and
a bearing point for receiving a pedal bearing,
wherein the shell consists of metal and the reinforcing element consists of plastic, and the bearing point is formed by the reinforcing element and the shell.

9. The pedal bearing block as claimed in claim 8, wherein the shell has an edge encircling it in some regions.

10. The pedal bearing block as claimed in claim 8, wherein the reinforcing element has ribs.

11. The pedal bearing block as claimed in claim 9, wherein the reinforcing element has ribs.

12. The pedal bearing block as claimed in claim 10, wherein the reinforcing element has ribs around the bearing point of the pedal bearing.

13. The pedal bearing block as claimed in claim 8, wherein the reinforcing element is secured on the shell.

14. The pedal bearing block as claimed in claim 9, wherein the reinforcing element substantially envelopes the encircling edge of the shell.

15. The pedal bearing block as claimed in claim 11, wherein the reinforcing element substantially envelopes the encircling edge of the shell.

16. The pedal bearing block as claimed in claim 8, wherein the reinforcing element has receiving elements for receiving functional elements.

17. The pedal bearing block as claimed in claim 9, wherein the reinforcing element has receiving elements for receiving functional elements.

18. The pedal bearing block as claimed in claim 12, wherein the reinforcing element has receiving elements for receiving functional elements.

19. The pedal bearing block as claimed in claim 13, wherein the reinforcing element has receiving elements for receiving functional elements.

20. The pedal bearing block as claimed in claim 14, wherein the reinforcing element has receiving elements for receiving functional elements.
